(19) United States
(12) Patent Application Publication
(10) Pub. No.: US 2022/0361510 A1
(43) Pub. Date: Nov. 17, 2022

(54) METHOD FOR MANUFACTURING PREGELATINIZED CEREAL FLOUR

(71) Applicants: Nisshin Seifun Group Inc., Tokyo (JP); NISSHIN FLOUR MILLING INC., Tokyo (JP); Nisshin Seifun Welna Inc., Tokyo (JP); NISSHIN SEIFUN PREMIX INC., Tokyo (JP)

(72) Inventors: Kenichiro TAKAMATSU, Fujimino-shi (JP); Yukako KOGO, Fujimino-shi (JP); Takao NAGAI, Tokyo (JP); Toru SHIGEMATSU, Tokyo (JP); Takahiro YAGISHITA, Tokyo (JP)

(73) Assignees: Nisshin Seifun Group Inc., Tokyo (JP); NISSHIN FLOUR MILLING INC., Tokyo (JP); Nisshin Seifun Welna Inc., Tokyo (JP); NISSHIN SEIFUN PREMIX INC., Tokyo (JP)

(21) Appl. No.: 17/765,371

(22) PCT Filed: Oct. 28, 2020
(86) PCT No.: PCT/JP2020/040336

§ 371 Date: Mar. 30, 2022

(30) Foreign Application Priority Data
Oct. 30, 2019 (JP) PCT/JP2019/042684

(51) Int. Cl. A21D 13/02; A21D 13/06; A21D 6/00; A23L 7/109; A23L 7/13; C08B 30/06; C08B 30/14

(52) U.S. Cl. CPC A21D 13/02; A21D 13/06; A21D 6/00; A23L 7/109; A23L 7/13; C08B 30/06; C08B 30/14

(57) ABSTRACT

A method for producing pregelatinized cereal flour according to the present invention includes: a pregelatinization step of heating a slurry containing 100 parts by mass of cereal flour and 500 parts by mass or more of water under a condition that the temperature of the slurry is 90° C. or more, to pregelatinize starch contained in the cereal flour; and a drying step of drying the slurry from the pregelatinization step to obtain a solid. In the pregelatinization step, the slurry is stirred while heating the slurry. In the pregelatinization step, the slurry is preferably heated under a condition that the temperature of the slurry is 100° C. or more. According to the present invention, there is provided pregelatinized starch that can improve the taste and texture of food and impart aging resistance to the food.

### TECHNICAL FIELD

The present invention relates to pregelatinized cereal flour suitable for food application.

### BACKGROUND ART

Pregelatinized starch is a starch that is obtained by heating raw starch in the presence of water to gelatinize (pregelatinize) the raw starch. Through pregelatinization, the molecular arrangement in starch particles collapse, which appears as irreversible changes in the properties of the starch particles, such as swelling of the starch particles, the loss of birefringence, melting of natural microcrystals, and solubilizing of starch. For this reason, pregelatinized starch exhibits unique properties different from those of raw starch, and thus is widely used in food applications, industrial applications, and other applications. A conventionally known method for producing pregelatinized starch includes drying a slurry that contains starch using a spray dryer, a drum dryer, or the like. Another known method includes adding water to starch and then heating the obtained mixture while kneading the mixture using an extruder, and still another method includes heating and humidifying starch by introducing superheated vapor into a container in which the starch is contained.

Patent Literature 1 discloses a method for producing modified starch that has desired swelling properties and water retention properties. In this method, water is added to raw starch to adjust the moisture content to 26 to 59 mass %, and thereafter, the particles of the raw starch are brought into contact with water vapor and/or hot water to increase the moisture content. Patent Literature 2 discloses a method for producing pregelatinized cereal flour that has a porous structure and is applicable to an aromatic component adsorbent, for example. In this method, 200 to 5000 parts by mass of water is added to 100 parts by mass of cereal flour, the mixture is then heat-gelatinized, and thereafter, alcohol is added, followed by freeze-drying the resulting mixture. In the method disclosed in Patent Literature 2, the heating temperature during heat gelatinization is kept at a temperature higher than or equal to the gelatinization temperature, and in Examples, the cereal flour was pregelatinized in a boiling water bath.

### CITATION LIST

### Patent Literature

Patent Literature 1: JP 2014-205776A

Patent Literature 2: JP H3-43052A

### SUMMARY OF INVENTION

In food that contains starch as a main ingredient, aging of the starch is a problem. For example, bakery food has the following problem. Aging of starch contained in bakery food progresses during preservation or storage of the bakery food. Bakery food has a fluffy texture immediately after production, but it turns into a hard and mealy texture or melts poorly in the mouth as the starch ages. Aging of starch is a phenomenon in which gelatinized starch releases moisture contained therein, and transforms into crystals of retrograded starch. There is a demand for a technique that can improve the taste and texture of food to a high level and prevent degradation over time such as aging.

It is an object of the present invention to provide pregelatinized starch that can improve the taste and texture of food and impart aging resistance to the food.

The present invention provides a method for producing pregelatinized cereal flour, the method including: a pregelatinization step of heating a slurry containing 100 parts by mass of cereal flour and 500 parts by mass or more of water under a condition that the temperature of the slurry is 90° C. or more, to pregelatinize starch contained in the cereal flour; and a drying step of drying the slurry from the pregelatinization step to obtain a solid; wherein, in the pregelatinization step, the slurry is stirred while heating the slurry.

The present invention also provides a method for producing processed food, wherein pregelatinized cereal flour produced using the method for producing pregelatinized cereal flour according to the present invention is used.

### DESCRIPTION OF EMBODIMENT

The method for producing pregelatinized cereal flour according to the invention includes: a step of heating an aqueous slurry containing cereal flour to pregelatinize (gelatinize) starch contained in the cereal flour (pregelatinization step); and a step of drying the slurry to obtain a solid (drying step). Hereinafter, the steps will be described.

### Pregelatinization Step

Examples of the cereal flour used in the present invention includes refined cereal flour (endosperm flour), starch, and whole grain cereal flour. These may be used singly or in a combination of two or more according to, for example, the application of food in which the pregelatinized cereal flour is to be incorporated. The cereal that serves as the source of the refined cereal flour, the starch, or the whole grain cereal flour may be non-glutinous or glutinous.

As the refined cereal flour that can be used as the cereal flour, any refined cereal flour can be used as long as it contains starch. Examples of the refined cereal flour include wheat flour, rice flour, buckwheat flour, rye flour, and soy flour. Examples of the wheat flour include soft wheat flour, medium wheat flour, strong wheat flour, durum wheat flour, and durum semolina flour. As the refined cereal flour, wheat flour is typically used.

Examples of the starch that can be used as the cereal flour include: native starches such as potato starch, wheat starch, corn starch, waxy corn starch, rice starch, and tapioca starch; and modified starches obtained by subjecting any of the native starches to at least one process such as treatment with oil/fat, etherification, esterification, acetylation, crosslinking, and oxidation. The term “starch” (the starch that can be used as the starting material in the pregelatinization step) here means “pure starch”, which has been isolated from a plant such as wheat and is distinguished from starch that is contained in cereal flour.

The whole grain cereal flour that can be used as the cereal flour is a flour that contains all three main components constituting a cereal caryopsis (cereal grain), i.e., an endosperm, an outer coating, and a germ. There is no particular limitation on the cereal that serves as the source of the whole grain cereal flour, as long as the cereal is acceptable for food use. Examples of the cereal include wheat, barley, oat, rye, and rice. In the present invention, a single kind of whole grain cereal flour may be used, or a combination of two or more kinds of whole grain cereal flour may be used. Herein, the term “cereal” in the term “whole grain cereal flour” may be replaced by the name of a cereal that serves as the source of the whole grain cereal flour in question. For example, the term “whole grain wheat flour” is used to mean a whole grain cereal flour derived from a wheat caryopsis, and the term “whole grain barley flour” is used to mean a whole grain cereal flour derived from a barley caryopsis. As the whole grain cereal flour, whole grain wheat flour is typically used.

The method for producing pregelatinized starch according to the present invention is characterized in that heating a slurry containing 100 parts by mass of cereal flour and 500 parts by mass or more of water under a condition that the temperature of the slurry is 90° C. or more is used as a means to pregelatinize starch contained in the cereal flour. In typical conventional pregelatinization, the amount of water added is much less than 500 parts by mass, and more specifically, often 100 parts by mass or less, per 100 parts by mass of cereal flour. Also, in typical conventional pregelatinization, the heating temperature is often such that the temperature of the heating target is less than 90° C. The conditions for pregelatinization of the cereal flour in the present invention are a large amount of water added and a high temperature, which are unprecedented conditions. Due to the pregelatinization under such conditions in the present invention, the starch undergoes a structural change different from that caused by conventional pregelatinization, and as a result of this, high-quality pregelatinized cereal flour that cannot be obtained using the conventional method can be obtained. Cereal flour usually contains a certain amount of moisture, and accordingly, the total amount of moisture in the slurry is the total of 500 parts by mass or more of water added per 100 parts by mass of cereal flour and the amount of moisture (usually about 15 parts by mass or less of moisture) inherently contained in the 100 parts by mass of the cereal flour.

Whole grain cereal flour advantageously contains an abundance of nutritional components and has a high dietary fiber content; however, whole grain cereal flour also has a distinctive odor (bran odor) and an astringent taste, and it is thus difficult to use whole grain cereal flour as a food material with willingness. In the present invention, by pregelatinizing whole grain cereal flour under the condition of a large amount of water added and a high temperature, the distinctive odor and the astringent taste are reduced to improve the palatability of whole grain cereal flour, without impairing the inherent advantages of whole grain cereal flour such as nutritiousness.

The temperature of the slurry, or in other words, the heating temperature in the pregelatinization step is at least 90° C. or more, preferably 100° C. or more, more preferably 105° C. or more, even more preferably 110 to 140° C., still more preferably 115 to 135° C., and even further preferably 120 to 130° C. As the heating temperature of the slurry is higher, the modification of starch generally progresses and thus the intended advantageous effect of the present invention is likely to be exhibited. However, when the heating temperature is too high, the internal pressure of a container containing the slurry needs to be managed, and also the required amount of heat of vapor or the like increases, which may lead to an increase in production cost and a reduction in productivity. Also, when wheat flour is processed at a temperature higher than 140° C., protein, amino acids, and others contained in the wheat flour may cause a Maillard reaction, and the wheat flour may undergo discoloration. For these reasons, the upper limit of the temperature of the slurry in the pregelatinization step is preferably about 140° C. Heating the slurry under a condition that the temperature of the slurry is higher than 100° C. can be performed by, for example, heating the slurry in a pressurized atmosphere.

In the pregelatinization step, the period of time during which the temperature of the slurry is kept at 90° C. or more (preferably 100° C. or more), or in other words, the heating duration is preferably 1 minute or more, and more preferably 3 minutes or more. On the other hand, the upper limit of the heating duration in the pregelatinization step is preferably 180 minutes or less, and more preferably 120 minutes or less in view of production efficiency, but the upper limit of the heating duration is not particularly limited thereto.

In the case where whole grain cereal flour is used as the cereal flour, the heating temperature of the slurry in the pregelatinization step is at least 90° C. or more, as described above, and is preferably 95° C. or more, and more preferably within the above-described range of 100° C. or more. The heating duration may be within the range as described above. By heating whole grain cereal flour under the above-described conditions in the pregelatinization step, the modifying effect on starch can be obtained, and in addition, the bran odor and the astringent taste of whole grain cereal flour caused by the outer coating (bran) of the whole grain cereal flour can be reduced.

The slurry, which is the heating target in the pregelatinization step, can be prepared by adding 500 parts by mass or more of water to 100 parts by mass of cereal flour. The amount of water added is preferably 600 to 2500 parts by mass, more preferably 700 to 2000 parts by mass, and even more preferably 800 to 1500 parts by mass, per 100 parts by mass of cereal flour. If the amount of water added is less than 500 parts by mass per 100 parts by mass of cereal flour, the intended advantageous effect of the present invention is not sufficiently exhibited. Conversely, if the amount of water added is too much, a large amount of time and energy is required to obtain a solid in the next step, i.e., the step of drying the slurry, which may lead to an increase in production cost and a reduction in productivity.

The slurry is typically composed only of the cereal flour (refined cereal flour, starch, whole grain cereal flour) and water as a solvent. However, the slurry may contain other components as needed, such as a cereal flour modifying agent, which can modify the cereal flour to have desired properties. Examples of the cereal flour modifying agent include a formulation for performing scientific processing, amylase, and an enzyme that breaks down the protein contained in the cereal flour (e.g., protease). In the slurry containing a cereal flour modifying agent, a reaction in which the cereal flour modifying agent is involved (e.g., an enzyme reaction) takes place. This reaction may be completed before the slurry is subjected to the pregelatinization step, or may be performed during the pregelatinization step.

As the cereal flour, pre-treated cereal flour may also be used. That is, the slurry may be prepared by adding water to pre-treated cereal flour. The pre-treatment of cereal flour can be performed by, for example, adding any of various agents (such as an enzyme, an acid or alkali agent, an emulsifier, and a catalyst) to the cereal flour.

In the pregelatinization step, there is no particular limitation on the method for heating the slurry (the method for pregelatinizing the cereal flour) as long as the method can be performed under the condition of a large amount of added water and a high temperature. A typical method for heating the slurry includes placing the slurry containing the cereal flour in a container and heating the container. The slurry may be heated batch-wise or continuously. As the container for containing the slurry when the slurry is heated, a pressure vessel may be used in the case where the slurry is heated batch-wise, and a line mixer such as a static mixer may be used in the case where the slurry is heated continuously. There is no particular limitation on the heating method, and electrically heating, gas heating, or vapor heating can be used, for example. These may be used singly or in a combination of two or more. For vapor heating, saturated vapor or superheated vapor may be introduced directly into the container containing a substance to be processed (cereal flour), for example.

In the pregelatinization step, it is necessary that the slurry is stirred while heating the slurry. If the slurry is heated in a stationary state without stirring, the cereal flour contained in the slurry may form lumps, which may result in insufficient or non-uniform pregelatinization (gelatinization). By stirring the slurry while heating, such a problem is prevented, and the pregelatinization of starch is facilitated. There is no particular limitation on the method for stirring the slurry as long as the cereal flour contained in the slurry can be dispersed throughout the slurry. Typically, the slurry can be stirred by a conventional method using a known container equipped with a stirring device that stirs the substance contained in the container. For example, in the case where the slurry is heated batch-wise, an apparatus that includes a stirring blade can be used, for example. In the case where the slurry is heated continuously, a static mixer can be used, for example. As a means for stirring the slurry, a known means to generate ultrasonic vibration can also be used. In this case, ultrasonic vibration generated by that means generates fine air bubbles in the slurry, and the fine air bubbles stir the slurry.

In the pregelatinization step, it is preferable that the amount of solvent (water) contained in the slurry should be not varied while heating the slurry, or in other words, during pregelatinization of the cereal flour. If the amount of solvent decreases (evaporates) significantly while heating the slurry, the facilitation of pregelatinization may be inhibited. Preferably, the pregelatinization is completed while the slurry contains 500 parts by mass or more of water per 100 parts by mass of cereal flour.

In order to prevent the amount of solvent contained in the slurry from varying while heating the slurry, the slurry may be heated in a pressurized atmosphere, for example. Specifically, the slurry may be heated at an atmospheric pressure above 1 atm pressure. In this case, the container containing the slurry is preferably pressure resistant. There is no particular limitation on the pressure of the pressurized atmosphere, and the pressure of the pressurized atmosphere may be adjusted as appropriate according to the amount of solvent contained in the slurry and the heating temperature (the temperature of the slurry). Because the upper limit of the temperature of the slurry heated depends on the pressure, the pressure of the pressurized atmosphere is preferably a pressure that corresponds to a desired heating temperature.

### Drying Step

In the drying step, the slurry that has undergone the pregelatinization step described above is dried to obtain a solid. The solid is pregelatinized cereal flour, which is the targeted product of the production method of the present invention. There is no particular limitation on the method for drying the slurry, and a known drying method can be used. Examples of the drying method include freeze-drying, spray drying using a spray dryer or the like, and heat-drying using a drum dryer. There is no particular limitation on the degree to which the slurry is dried, but typically, the slurry is dried until the moisture content of the solid obtained by drying the slurry is about the same as the moisture content of ordinary cereal flour (the cereal flour used in the pregelatinization step as a starting material). The moisture content of ordinary cereal flour is usually about 15 mass %.

The solid obtained from the drying step, or in other words, the pregelatinized cereal flour may be pulverized into powder as needed. The solid can be pulverized by a conventional method using a household pulverizing machine such as a coffee mill or a juicer, or an industrial pulverizing machine such as a hammer mill, a pin mill, or a jet mill. The solid may be pulverized to a desired grain size.

The pregelatinized cereal flour produced using the production method of the present invention may have a pregelatinization degree (gelatinization degree) of preferably 90% or more, and more preferably 95% or more. By incorporating the pregelatinized cereal flour having such a high pregelatinization degree into a food item, the taste and texture of the food item are improved significantly, and aging resistance is also imparted to the food item. Herein, the term “pregelatinization degree” refers to a pregelatinization degree measured using the BAP method (β-amylase pullulanase method). Measurement of the pregelatinization degree using the BAP method can be performed in the following manner in accordance with a publication (Journal of Home Economics of Japan 32 (9), 653-659, 1981).

### Method for Measuring Pregelatinization Degree Using β-Amylase Pullulanase Method

### (A) Reagent

The following reagents are used:

1) 0.8 M acetic acid-sodium acetate buffer solution;

2) 10 N sodium hydroxide solution;

3) 2 N acetic acid solution;

4) enzyme solution: a solution prepared by dissolving 0.017 g of β-amylase (#1500S, available from Nagase ChemteX Corporation) and 0.17 g of pullulanase (No. 31001, available from Hayashibara Biochemical Labs, Inc.) in the above-listed 0.8 M acetic acid-sodium acetate buffer solution and adjusting the volume to 100 mL;

5) deactivated enzyme solution: a solution prepared by boiling the above enzyme solution for 10 minutes; and

6) Somogyi reagent and Nelson reagent (reagents for measuring the amount of reducing sugar).

### (B) Measurement Method

B-1) A sample of cereal flour (pregelatinized cereal flour) is pulverized using a homogenizer to a size of 100 mesh or less. 0.08 to 0.10 g of the pulverized sample of cereal flour is introduced into a glass homogenizer.

B-2) 8.0 mL of desalinated water is added to the pulverized sample of cereal flour in the glass homogenizer, and the glass homogenizer is moved up and down 10 to 20 times to disperse the pulverized sample to obtain a dispersion.

B-3) 2 mL of the dispersion obtained from B-2) is introduced into each of two 25 mL graduated test tubes. The dispersion in one of the two test tubes is adjusted to the specific volume by adding 0.8 M of acetic acid-sodium acetate buffer, and the resultant is used as a test section.

B-4) 0.2 mL of 10 N sodium hydroxide solution is added to the other one of the two test tubes, and a reaction of the resultant is performed at 50° C. for 3 to 5 minutes to completely gelatinize the dispersion obtained from B-2). After that, 1.0 mL of 2 N acetic acid solution is added to the test tube to adjust the pH to around 6.0, and then 0.8 M of acetic acid-sodium acetate buffer solution is added to adjust the volume to the specific volume. The resultant is used as a gelatinization section.

B-5) 0.1 mL of enzyme solution is added to 0.4 mL of each of the test liquid of the test section prepared in B-3) and the test liquid of the gelatinization section prepared in B-4), and an enzyme reaction of each is performed at 40° C. for 30 minutes to obtain a reacted solution. Separately, blank samples are also prepared by adding 0.1 mL of deactivated enzyme solution instead of the enzyme solution. The enzyme reaction is performed while occasionally stirring the reaction solution.

B-6) 0.5 mL of Somogyi reagent is added to 0.5 mL of each of the reacted solutions and the blank samples, and the resulting mixtures are then boiled for 15 minutes in a boiling water bath. After boiling, the mixtures are cooled with running water for 5 minutes. Thereafter, 1.0 mL of Nelson reagent is added to each, and the mixtures are each stirred and left for 15 minutes.

B-7) Then, 8.00 mL of desalinated water is added to each of the reacted solutions and the blank samples, and the resulting mixtures are each stirred. Then, absorbance at 500 nm is measured.

### (C) Calculation of Pregelatinization Degree

Pregelatinization degree is calculated using the following equation:

Pregelatinization degree (%)={(decomposition rate of test liquid)/(decomposition rate of completely gelatinized test liquid)}×100={(A−a)/(A′−a′)}×100

wherein

A=the absorbance of the test section

A′=the absorbance of the gelatinization section

a=the absorbance of the blank sample of the test section

a′=the absorbance of the blank sample of the gelatinization section.

The pregelatinized cereal flour produced using the production method of the present invention (hereinafter also referred to simply as “pregelatinized cereal flour of the present invention”) can replace known pregelatinized cereal flour or pregelatinized starch. Typically, the pregelatinized cereal flour of the present invention is used in the field of the food industry, but may also be used in other fields. Examples of the use of the pregelatinized cereal flour of the present invention in the field of the food industry include: 1) a thickener or a shape retentioner in applications that do not involve heat cooking (for example, instant soup); 2) a modifier used for a batter or dough made from a cake mix or a stabilizer for stabilizing the structure of frozen food; 3) a substitute for a soup powder or a rakugan powder (rakugan is traditional Japanese sweets made by pressing a mixture of starch, sugar, and others into a wooden mold) in the case where the pregelatinized cereal flour of the present invention is produced by using corn starch as the cereal flour; and 4) a coating for coated bean snacks in the case where the pregelatinized cereal flour of the present invention is produced by using waxy corn starch as the cereal flour. Also, for the case where the pregelatinized cereal flour of the present invention is produced by using potato starch as the cereal flour, examples of the use of the pregelatinized cereal flour of the present invention in fields other than a field of the food industry include a binder for fodder; binders for foundry sand molds, incense sticks, grinding wheels, and others; laundry starch for household use; and a paper strength-enhancing agent.

The pregelatinized cereal flour can be used to produce processed food. As used herein, the term “processed food” refers to food produced by using cereal flour as an ingredient. Examples of the processed food include: bakery food; noodles such as udon noodles, somen noodles, hiyamugi noodles, Chinese noodles, pasta, instant noodles (including non-fried instant noodles); fried food such as tempura, (Japanese-style fritter), kara-age fried chicken, tatsuta-age fried chicken, and fritters; other deep fried food (food produced through a deep frying process); and powdered food such as instant soup. The noodles encompass wrappers such as a gyoza dumpling wrapper, a shumai dumpling wrapper, and a spring roll wrapper. The processed food may be frozen food. By using the pregelatinized cereal flour of the present invention to produce the processed food items described above, it is possible to improve the taste and texture of the food items and impart aging resistance to the food items, and in the case of instant noodles, the effect of improving reconstitution thereof with hot water or the like is also obtained. The processed food can be produced using a conventional method according to the type thereof.

The pregelatinized cereal flour of the present invention is suitable for producing of bakery food. By incorporating the pregelatinized starch into bakery food, a fluffy and soft texture, a moist texture, and pleasant stickiness are imparted to the bakery food, and aging resistance is also imparted thereto to lead to prevention of degradation in terms of taste and texture over time. Bakery food refers to foods obtained by allowing a fermented or non-fermented dough or batter to cook, the dough or batter containing cereal flour (refined cereal flour, starch, whole grain cereal flour, or the like) as an essential ingredient and optional ingredients such as a yeast, a leavening agent (e.g., baking powder), water, cooking salt, and sugar as needed. Specific examples of the bakery food include: breads; pizzas; cakes; Japanese and Western baked sweets such as waffles, cream puffs, biscuits, and yaki-manju (Japanese grilled sweet buns); and deep-fried sweets such as doughnuts. Examples of the breads include: plain bread (for example, bread rolls, white bread, rye bread, French bread, hardtack, hotdog buns, and croissants); savory bread; and sweet bread. Examples of the cakes include sponge cake, butter cake, rolled cake, pancakes, bouchëe, Baumkuchen, pound cake, cheesecake, snack cake, muffins, bars, and cookies.

### EXAMPLES

The present invention will now be described in further detail by way of examples, but the present invention is not limited to the examples given below.

### Examples 1 to 10 and Comparative Examples 1 to 5

An aqueous slurry was prepared by adding a predetermined amount of water to wheat flour as the cereal flour. The slurry was placed in a pressure vessel equipped with a stirrer (a paddle rotatably attached to the pressure vessel), and the slurry was heated at a heating temperature using a heating method shown in Table 1 given below while stirring the slurry using the stirrer, to thereby pregelatinize (gelatinize) the starch contained in the wheat flour as the cereal flour (pregelatinization step). The heating duration (the period of time during which the heating temperature shown in Table 1 was kept) in the pregelatinization step was 1 minute, 3 minutes, or 30 minutes. Next, the slurry (gelatinized liquid) from the pregelatinization step was subjected to freeze-drying using a commercially available freeze-drying machine (product name “Genesis SQ”, available from SP Industries, Inc.), to thereby obtain a solid. Next, the solid was pulverized using a commercially available coffee mill. In this way, pregelatinized wheat flour (pregelatinized cereal flour) as the target product was obtained (Examples 1 to 10 and Comparative Examples 1 and 3).

Pregelatinized wheat flour was obtained in the same manner as described above, except that 30 parts by mass of water was added to 100 parts by mass of wheat flour, and that the slurry was heated at a predetermined heating temperature for a predetermined period of time using an extruder (Comparative Example 2).

Pregelatinized wheat flour was produced without stirring the slurry while heating the slurry in the pregelatinization step. Specifically, an aqueous slurry was prepared by adding a predetermined amount of water to wheat flour, the slurry was placed in a retort pouch, and the retort pouch was hermetically sealed and then heated to reach 120° C. for 3 minutes using an autoclave. Then, the same subsequent procedure as described above was performed to obtain pregelatinized wheat flour (Comparative Examples 4 and 5). In this method, water separated from the slurry due to heating using an autoclave, or in other words, due to the pregelatinization step. Thus the slurry had a non-uniform viscosity (partially formed lumps), and gelatinization was not uniform. Also, since lumps were formed in the slurry, the efficiency was also poor in freeze-drying the slurry and pulverizing the solid into a powder.

TABLE 1

| | | Comp. Ex. | Example | | | | | |
|---|---|---|---|---|---|---|---|---|
| | | 1 | 1 | 2 | 3 | 3A | 4 | 4A |
| Pregelatinization | Type of cereal flour | Wheat | Wheat | Wheat | Wheat | Wheat | Wheat | Wheat |
| step | | Flour | Flour | Flour | Flour | Flour | Flour | Flour |
| | Amount of cereal flour used | 100 | 100 | 100 | 100 | 100 | 100 | 100 |
| | (parts by mass) | | | | | | | |
| | Amount of water added | 625 | 625 | 625 | 625 | 625 | 625 | 625 |
| | (parts by mass) | | | | | | | |
| | Heating method | A | A | A | A | A | A | A |
| | Heating temperature | 85 | 95 | 105 | 110 | 110 | 120 | 120 |
| | (Temperature of heating | | | | | | | |
| | target) (° C.) | | | | | | | |
| | Heating duration (min) | 3 | 3 | 3 | 3 | 30 | 3 | 1 |

| | | Example | | | | | | |
|---|---|---|---|---|---|---|---|---|
| | | 4B | 5 | 6 | 7 | 8 | 8A | 9 |
| Pregelatinization | Type of cereal flour | Wheat | Wheat | Wheat | Wheat | Wheat | Wheat | Wheat |
| step | | Flour | Flour | Flour | Flour | Flour | Flour | Flour |
| | Amount of cereal flour used | 100 | 100 | 100 | 100 | 100 | 100 | 100 |
| | (parts by mass) | | | | | | | |
| | Amount of water added | 625 | 625 | 750 | 750 | 1000 | 1000 | 1000 |
| | (parts by mass) | | | | | | | |
| | Heating method | A | A | A | A | A | A | A |
| | Heating temperature | 120 | 140 | 120 | 140 | 120 | 120 | 140 |
| | (Temperature of heating | | | | | | | |
| | target) (° C.) | | | | | | | |
| | Heating duration (min) | 30 | 3 | 3 | 3 | 3 | 1 | 3 |

| | | Comparative Example | | | | Example |
|---|---|---|---|---|---|---|
| | | 2 | 3 | 4 | 5 | 10 |
| Pregelatinization | Type of cereal flour | Wheat | Wheat | Wheat | Wheat | Wheat |
| step | | Flour | Flour | Flour | Flour | Flour |
| | Amount of cereal flour used | 100 | 100 | 100 | 100 | 100 |
| | (parts by mass) | | | | | |
| | Amount of water added | 30 | 300 | 625 | 1000 | 500 |
| | (parts by mass) | | | | | |
| | Heating method | B | A | C | C | A |
| | Heating temperature | 95 | 120 | 120 | 120 | 120 |
| | (Temperature of heating | | | | | |
| | target) (° C.) | | | | | |
| | Heating duration (min) | 3 | 3 | 3 | 3 | 3 |

Heating method A: A slurry containing cereal flour was prepared, and the slurry was heated while stirring the slurry.
Heating method B: Water was added to cereal flour, and the resultant was heated while kneading it using an extruder.
Heating method C: A slurry containing cereal flour was prepared, and the slurry was heated using an autoclave without stirring the slurry.

### Examples 11 to 16 and Comparative Examples 6 to 8

Pregelatinized whole grain wheat flour, pregelatinized corn starch, and pregelatinized wheat starch were obtained in the same manner as in Examples or Comparative Examples described above, except that whole grain wheat flour, corn starch, and wheat starch were used as the cereal flour, and that the pregelatinization step was performed under a condition shown in Table 2 given below.

TABLE 2

| | | Comp. Ex. | Example | | | |
|---|---|---|---|---|---|---|
| | | 6 | 11 | 12 | 13 | 14 |
| Pregelatinization | Type of cereal flour | Whole grain | Whole grain | Whole grain | Whole grain | Corn |
| step | | wheat flour | wheat flour | wheat flour | wheat flour | starch |
| | Amount of cereal flour used | 100 | 100 | 100 | 100 | 100 |
| | (parts by mass) | | | | | |
| | Amount of water added | 625 | 625 | 750 | 1000 | 1000 |
| | (parts by mass) | | | | | |
| | Heating method | A | A | A | A | A |
| | Heating temperature | 85 | 95 | 120 | 120 | 120 |
| | (Temperature of heating | | | | | |
| | target) (° C.) | | | | | |

| | | Example | Comparative Example | | Example |
|---|---|---|---|---|---|
| | | 15 | 7 | 8 | 16 |
| Pregelatinization | Type of cereal flour | Wheat | Whole grain | Whole grain | Whole grain |
| step | | starch | wheat flour | wheat flour | wheat flour |
| | Amount of cereal flour used | 100 | 100 | 100 | 100 |
| | (parts by mass) | | | | |
| | Amount of water added | 1000 | 30 | 300 | 500 |
| | (parts by mass) | | | | |
| | Heating method | A | B | A | A |
| | Heating temperature | 120 | 95 | 120 | 120 |
| | (Temperature of heating | | | | |
| | target) (° C.) | | | | |

Heating method A: A slurry containing cereal flour was prepared, and the slurry was heated while stirring the slurry.
Heating method B: Water was added to cereal flour used as a starting material, and the resultant was heated while kneading it using an extruder.

### Production Examples A1 to A22: Production of Pancake

A pancake, which is a kind of bakery food, was produced by using a baking mix for sweets according to a composition shown in Table 3 given below. Specifically, 100 parts by mass of the mix, 25 parts by mass of sugar, 5 parts by mass of baking powder, 10 parts by mass of salad oil, 30 parts by mass of whole egg, 50 parts by mass of milk, and an appropriate amount of water were placed in a container, and were manually mixed and stirred at a rotation speed of 120 rpm to prepare a pancake batter with a viscosity of 5 to 10 Pa·s as measured using a B-type viscometer at a batter temperature of 25° C. The amount of water added was set such that the viscosity of the pancake batter would be within the above-described range. The prepared pancake batter was allowed to rest for 10 minutes. After that, 55 g of the batter was poured onto a griddle plate, and one side of the batter was allowed to cook for 3 minutes on the plate set at a temperature of 180° C. The resultant was then flipped upside down to cook on the other side for 2 minutes, followed by slightly cooling. In this way, pancakes were produced in each production example.

One of the pancakes produced in the above-described manner was allowed to cool in an environment at room temperature for 30 minutes, and thereafter was eaten by 10 expert panelists to evaluate the texture (the texture immediately after production) of the pancake on the following evaluation criteria (perfect score: 5 points).

Also, another one of the produced pancakes was placed in a refrigerator having an internal temperature of 4° C., and stored for 3 days to obtain a chilled pancake. The chilled pancake was left in an environment at room temperature for 20 minutes and cut into an appropriate size, and the resulting pieces were eaten by 10 expert panelists to evaluate the texture (texture after chilled storage) of the pancake on the following evaluation criteria (perfect score: 5 points).

Also, yet another one of the produced pancakes was placed in a freezer having an internal temperature of −18° C., and stored for 2 months to obtain a frozen pancake. The frozen pancake was left in an environment at room temperature for 20 minutes and cut into an appropriate size, and the resulting pieces were eaten by 10 expert panelists to evaluate the texture (texture after frozen storage) of the pancake on the following evaluation criteria (perfect score: 5 points).

The results (the average of evaluation scores from the 10 panelists) are shown in Table 3 given below.

### Evaluation Criteria for Texture of Pancake

5 points: The inside of the pancake was fluffy and soft with a moist texture, and the biting texture and the melt-in-the-mouth texture were good.

4 points: The inside of the pancake was fluffy and soft, and the biting texture and the melt-in-the-mouth texture were somewhat good.

3 points: The inside of the pancake was somewhat fluffy but somewhat stretchy, giving an impression of aged starch, and the biting texture and the melt-in-the-mouth texture were somewhat insufficient; however, the pancake was satisfactory.

2 points: The inside of the pancake was less fluffy and also stretchy with mealy texture, giving a strong impression of aged starch, and thus the biting texture and the melt-in-the-mouth texture were poor.

1 point: The inside of the pancake was hard and also very stretchy with very mealy texture, giving a very strong impression of aged starch, and accordingly, the biting texture and the melt-in-the-mouth texture were very poor.

TABLE 3

Production Example A

| | | 1 | 2 | 3 | 4 | 5 | 6 | 7 | 8 | 9 | 10 | 11 |
|---|---|---|---|---|---|---|---|---|---|---|---|---|
| Composition | Pregelatinized wheat flour used | — | Comp. | Ex. 1 | Ex. 2 | Ex. 3 | Ex. 3A | Ex. 4 | Ex. 4A | Ex. 4B | Ex. 5 | Ex. 6 |
| of mix | | | Ex. 1 | | | | | | | | | |
| | Pregelatinized com starch used | — | — | — | — | — | — | — | — | — | — | — |
| | Pregelatinized wheat starch used | — | — | — | — | — | — | — | — | — | — | — |
| | Pregelatinized wheat flour | — | 10 | 10 | 10 | 10 | 10 | 10 | 10 | 10 | 10 | 10 |
| | (parts by mass) | | | | | | | | | | | |
| | Pregelatinized com starch | — | — | — | — | — | — | — | — | — | — | — |
| | (parts by mass) | | | | | | | | | | | |
| | Pregelatinized wheat starch | — | — | — | — | — | — | — | — | — | — | — |
| | (parts by mass) | | | | | | | | | | | |
| | Wheat flour | 100 | 90 | 90 | 90 | 90 | 90 | 90 | 90 | 90 | 90 | 90 |
| | (parts by mass) | | | | | | | | | | | |
| Texture of | Immediately after production | 4.0 | 4.1 | 4.4 | 4.5 | 4.5 | 4.5 | 4.6 | 4.6 | 4.6 | 4.5 | 4.8 |
| pancake | (Perfect score: 5 points) | | | | | | | | | | | |
| | After refrigerated storage*¹ | 1.5 | 3.0 | 3.2 | 3.5 | 3.8 | 3.9 | 4.2 | 4.2 | 4.3 | 4.1 | 4.4 |
| | (Perfect score: 5 points) | | | | | | | | | | | |
| | After frozen storage*² | 1.0 | 3.2 | 3.5 | 3.7 | 4.0 | 4.1 | 4.4 | 4.3 | 4.4 | 4.4 | 4.5 |
| | (Perfect score: 5 points) | | | | | | | | | | | |

| | | Production Example A | | | | | | | | | | |
|---|---|---|---|---|---|---|---|---|---|---|---|---|
| | | 12 | 13 | 14 | 15 | 16 | 17 | 18 | 19 | 20 | 21 | 22 |
| Composition | Pregelatinized wheat flour used | Ex. 7 | Ex. 8 | Ex. 8A | Ex. 9 | Comp. | Comp. | Comp. | Comp. | Ex 10 | — | — |
| of mix | | | | | | Ex 2 | Ex 3 | Ex 4 | Ex 5 | | | |
| | Pregelatinized com starch used | — | — | — | — | — | — | — | — | — | Ex 14 | — |
| | Pregelatinized wheat starch used | — | — | — | — | — | — | — | — | — | — | Ex 15 |
| | Pregelatinized wheat flour | 10 | 10 | 10 | 10 | 10 | 10 | 10 | 10 | 10 | — | — |
| | (parts by mass) | | | | | | | | | | | |
| | Pregelatinized com starch | — | — | — | — | — | — | — | — | — | 10 | — |
| | (parts by mass) | | | | | | | | | | | |
| | Pregelatinized wheat starch | — | — | — | — | — | — | — | — | — | — | 10 |
| | (parts by mass) | | | | | | | | | | | |
| | Wheat flour | 90 | 90 | 90 | 90 | 90 | 90 | 90 | 90 | 90 | 90 | 90 |
| | (parts by mass) | | | | | | | | | | | |
| Texture of | Immediately after production | 4.8 | 5.0 | 4.9 | 4.8 | 4.2 | 4.4 | 4.1 | 4.1 | 4.6 | 4.1 | 4.4 |
| pancake | (Perfect score: 5 points) | | | | | | | | | | | |
| | After refrigerated storage*¹ | 4.3 | 4.6 | 4.6 | 4.4 | 3.0 | 3.3 | 2.8 | 2.8 | 3.8 | 3.5 | 4.0 |
| | (Perfect score: 5 points) | | | | | | | | | | | |
| | After frozen storage*² | 4.5 | 4.5 | 4.5 | 4.5 | 3.5 | 3.7 | 3.0 | 3.0 | 4.2 | 3.8 | 4.1 |
| | (Perfect score: 5 points) | | | | | | | | | | | |

*¹Storage period was 3 days.
*²Storage period was 2 months.

### Production Examples B1 to B8: Production of Bread

A loaf of bread, which is a kind of bakery food, was produced by using a bread mix according to a composition shown in Table 4 given below with a commercially available home breadmaker (product name “SD-BM 103”, available from Panasonic Corporation). Specifically, 100 parts by mass of the bread mix, 4 parts by mass of butter, 6.8 parts by mass of sugar, 2.4 parts by mass of skimmed milk, 2 parts by mass of cooking salt, and 1.1 parts by mass of dry yeast were placed in the home breadmaker, and a “regular course” pre-programmed in the home breadmaker was selected. In this way, a loaf of bread was produced in each production example.

A portion of the loaf of bread produced in the above-described manner was allowed to cool in an environment at room temperature for 30 minutes, and thereafter was eaten by 10 expert panelists to evaluate the tactile feel, the texture, and the taste (the tactile feel, the texture, and the taste immediately after production) of the loaf of bread on the following evaluation criteria (perfect score: 5 points or 3 points). The results (the average of evaluation scores from the 10 panelists) are shown in Table 4 given below.

### Evaluation Criteria for Tactile Feel of Bread

5 points: The inside of the bread was fluffy, soft and moist.

4 points: The inside of the bread was fluffy, soft, and somewhat moist.

3 points: The inside of the bread was somewhat fluffy and moist.

2 points: The inside of the bread was less fluffy with mealiness.

1 point: The inside of the bread was hard and dry.

### Evaluation Criteria for Texture of Bread

3 points: The bread was moist and pleasantly sticky.

2 points: The bread was somewhat pleasantly sticky.

1 point: The bread was crispy with less pleasant stickiness.

### Evaluation Criteria for Taste of Bread

5 points: An aromatic smell of cereal was strongly perceived, and sweetness was also perceived.

4 points: An aromatic smell of cereal was perceived, and sweetness was also perceived without any astringent taste.

3 points: A bran odor and an astringent taste were perceived at a tolerable level.

2 points: A bran odor was somewhat strongly perceived, and an astringent taste was perceived.

1 point: A bran odor and an astringent taste were strongly perceived.

TABLE 4

| | | Production Example B | | | | | | | |
|---|---|---|---|---|---|---|---|---|---|
| | | 1 | 2 | 3 | 4 | 5 | 6 | 7 | 8 |
| Composition | Pregelatinized whole grain | — | Comp. | Ex. 11 | Ex. 1 12 | Ex. 13 | Comp. | Comp. | Ex. 16 |
| of mix | wheat flour used | | Ex. 6 | | | | Ex. 7 | Ex. 8 | |
| | Pregelatinized whole grain | — | 30 | 30 | 30 | 30 | 30 | 30 | 30 |
| | wheat flour (parts by mass) | | | | | | | | |
| | Whole grain wheat flour | 30 | — | — | — | — | — | — | — |
| | (parts by mass) | | | | | | | | |
| | Wheat flour (parts by mass) | 70 | 70 | 70 | 70 | 70 | 70 | 70 | 70 |
| Tactile feel of | Immediately after production | 2.0 | 2.4 | 3.0 | 4.2 | 4.8 | 3.0 | 2.6 | 3.8 |
| bread | (Perfect score: 5 point) | | | | | | | | |
| Texture of | Immediately after production | 1.0 | 1.7 | 2.0 | 2.5 | 3.0 | 2.0 | 1.8 | 2.3 |
| bread | (Perfect score: 3 points) | | | | | | | | |
| Taste of bread | Immediately after production | 1.5 | 2.6 | 3.5 | 4.2 | 4.6 | 2.2 | 3.0 | 3.8 |
| | (Perfect score: 5 points) | | | | | | | | |

### Production Examples C1 to C5: Production of Instant Noodles

Non-fried instant Chinese noodles, which is a kind of noodles, were produced by using a flour composition as ingredient shown in Table 5 given below. In the flour composition as ingredient, medium wheat flour (“Tokusuzume” available from Nisshin Seifun Co., Ltd.) was used as wheat flour, and oxidized tapioca starch (“MKK 100” available from Matsutani Chemical Industry Co., Ltd.) was used as starch. The specific production method was as follows. First, 1 part by mass of cooking salt and 0.4 parts by mass of kansui (noodle improver) (“Kansui Powder AKA” available from Oriental Yeast Co., Ltd.) were dissolved in an appropriate amount of water, and the resulting aqueous solution was added to 100 parts by mass of the flour composition, followed by kneading the resultant by a conventional method using a mixer for noodle making for 10 minutes to prepare a noodle dough. Next, the noodle dough was rolled using a roller for noodle making to a dough thickness of 1.2 mm, and cut into noodle strings using a blade (#18 square blade). Then, the noodle strings were steam cooked with vapor at a temperature of 100° C. for 2 minutes and 30 seconds, and then dried with hot air at 90° C. for 20 minutes, to thereby obtain non-fried instant Chinese noodles.

70 g of the instant noodles produced in the manner described above were placed in a container, and 450 ml of boiling water was poured into the container. A cover was placed on the container, which was then left for 4 minutes, and the hot water in the container was drained. After that, the instant noodles were eaten by 10 expert panelists to evaluate the reconstitution of the instant noodles with hot water and the texture (viscoelasticity) of the instant noodles on the following evaluation criteria. The results (the average of evaluation scores from the 10 panelists) are shown in Table 5 given below.

### Evaluation Criteria for Restoration of Instant Noodles

5 points: The noodles were sufficiently reconstituted into the ready-to-eat state.

4 points: The noodles were mostly reconstituted into the ready-to-eat state.

3 points: Most of the noodles were reconstituted into the ready-to-eat state, but some of the noodles were not sufficiently reconstituted with the center remaining hard.

2 points: The surfaces of the noodle strings were reconstituted, but the centers of the noodle strings remained hard.

1 point: Both the surfaces and the centers of the noodle strings remained hard.

### Evaluation Criteria for Texture of Instant Noodles

5 points: The texture was very good, with a very good balance between viscosity and elasticity.

4 points: The texture was good, with a good balance between viscosity and elasticity.

3 points: The texture was somewhat good, with a somewhat good balance between viscosity and elasticity.

2 points: The texture was somewhat poor, with a somewhat poor balance between viscosity and elasticity.

1 point: The texture was poor, with a poor balance between viscosity and elasticity.

TABLE 5

| | | Production Example C | | | | |
|---|---|---|---|---|---|---|
| | | 1 | 2 | 3 | 4 | 5 |
| Flour composition | Pregelatinized wheat flour used | — | Comp. Ex. 1 | Ex. 4 | Ex. 8 | Comp. Ex. 2 |
| as ingredient | Pregelatinized wheat flour | — | 5 | 5 | 5 | 5 |
| | (parts by mass) | | | | | |
| | Wheat flour (parts by mass) | 75 | 70 | 70 | 70 | 70 |
| | Starch (parts by mass) | 25 | 25 | 25 | 25 | 25 |

| | | | | | |
|---|---|---|---|---|---|
| Reconstruction of instant noodles | 3.0 | 3.9 | 4.6 | 4.8 | 4.0 |
| (Perfect score: 5 points) | | | | | |
| Texture of instant noodles | 2.5 | 3.7 | 4.4 | 4.6 | 3.8 |
| (Perfect score: 5 points) | | | | | |

### Production Examples D1 to D7: Production of Refrigerated Boiled Udon Noodles

Refrigerated boiled udon noodles, which is a kind of noodles (refrigerated cooked noodles), were produced by using a flour composition of as ingredient shown in Table 6 given below. In the flour composition as ingredient, medium wheat flour (“Kumpu” available from Nisshin Seifun Co., Ltd.) was used as wheat flour, acetylated tapioca starch (“Ajisai” available from Matsutani Chemical Industry Co., Ltd.) was used as starch, and “A-gluG” available from Glico Nutrition Co., Ltd. was used as wheat protein. The specific production method was as follows. First, 3 parts by mass of cooking salt was dissolved in an appropriate amount of water, and the resulting aqueous solution was added to 100 parts by mass of the flour composition, followed by kneading the resultant under a reduced pressure of −90 kPa to prepare a noodle dough. Next, the noodle dough was rolled and cut into noodle strings with a thickness of 3 mm using a blade (#10 square blade). The noodle strings were boiled in boiling water, rinsed with water, and cooled. Then, 3 parts by mass of noodle-loosening agent (“SOYA-UP M 3000” available from Fuji Oil Co., Ltd.) was sprayed on 100 parts by mass of the cooled noodle strings to be attached uniformly thereto, to thereby obtain boiled udon noodles. The boiled udon noodles were stored in a refrigerator having an internal temperature of 5° C. for 24 hours, to thereby obtain refrigerated boiled udon noodles.

The refrigerated boiled udon noodles produced in the above-described manner were eaten in the refrigerated state by 10 expert panelists to evaluate the texture (viscoelasticity) of the udon noodles on the following evaluation criteria (perfect score: 5 points). The results (the average of evaluation scores from the 10 panelists) are shown in Table 6 given below.

### Evaluation Criteria for Texture of Refrigerated Boiled Udon Noodles

5 points: The texture was very good, with a very good balance between viscosity and elasticity.

4 points: The texture was good, with a good balance between viscosity and elasticity.

3 points: The texture was somewhat good, with a somewhat good balance between viscosity and elasticity.

2 points: The texture was somewhat poor, with a somewhat poor balance between viscosity and elasticity.

1 point: The texture was poor, with a poor balance between viscosity and elasticity.

TABLE 6

| | | Production Example D | | | | | | |
|---|---|---|---|---|---|---|---|---|
| | | 1 | 2 | 3 | 4 | 5 | 6 | 7 |
| Flour | Pregelatinized wheat flour used | — | Comp. | Ex. 4 | Ex. 8 | Comp. | Ex. 8 | Ex. 8 |
| composition | | | Ex. 1 | | | Ex. 2 | | |
| as ingredient | Pregelatinized wheat flour | — | 10 | 10 | 10 | 10 | 20 | 30 |
| | (parts by mass) | | | | | | | |
| | Wheat flour (parts by mass) | 55 | 45 | 45 | 45 | 45 | 35 | 35 |
| | Starch (parts by mass) | 40 | 40 | 40 | 40 | 40 | 40 | 30 |
| | Wheat protein (parts by mass) | 5 | 5 | 5 | 5 | 5 | 5 | 5 |

| | | | | | | | |
|---|---|---|---|---|---|---|---|
| Texture of refrigerated boiled udon noodles | 3.0 | 3.8 | 4.4 | 4.6 | 3.9 | 4.4 | 4.5 |
| (Perfect score: 5 points) | | | | | | | |

### Production Examples E1 to E5: Production of Refrigerated Pan-Fried Gyoza Dumplings

Gyoza dumpling wrappers, which is a kind of noodle (wrapper), were produced by using a flour composition as ingredient shown in Table 7 given below. Furthermore, refrigerated pan-fried gyoza dumplings, which is a type of refrigerated cooked gyoza dumpling, were produced by using the resulting gyoza dumpling wrappers. The specific production method was as follows. First, 1 part by mass of cooking salt and an appropriate amount of water were added to 100 parts by mass of the flour composition as ingredient, and the resultant was then kneaded for 10 minutes, followed by allowing to rest for 30 minutes to obtain a dough. Next, the dough was rolled by a conventional method to a final dough thickness of 1 mm, and then cut using a mold with a diameter of 85 mm to obtain raw gyoza dumpling wrappers. Next, 12 g of filling for gyoza dumplings was wrapped in each of the raw gyoza dumpling wrappers to produce raw gyoza dumplings. The raw gyoza dumplings were pan-fried and thereafter stored in a refrigerator having an internal temperature of 4° C. for 3 days, to thereby obtain refrigerated pan-fried gyoza dumplings.

Five refrigerated pan-fried gyoza dumplings produced in the above-described manner were placed in a heat resistant container and heated in a microwave oven (at 500 W for 1 minute and 30 seconds). After that, the gyoza dumplings were eaten by 10 expert panelists to evaluate the texture of the gyoza dumplings on the following evaluation criteria (perfect score: 5 points). The results (the average of evaluation scores from the 10 panelists) are shown in Table 7 given below.

### Evaluation Criteria for Texture of Pan-Fried Gyoza Dumplings

5 points: The texture was good, with a very good melt-in-the-mouth texture and no hardness.

4 points: The texture was somewhat good, with a good melt-in-the-mouth texture and no hardness.

3 points: The texture was fair with a moderate melt-in-the-mouth texture and moderate hardness.

2 points: The texture was somewhat poor, with a poor melt-in-the-mouth texture and hardness.

1 point: Poor. The texture was poor, with a very poor melt-in-the-mouth texture and a hard texture.

TABLE 7

| | | Production Example E | | | | |
|---|---|---|---|---|---|---|
| | | 1 | 2 | 3 | 4 | 5 |
| Flour composition | Pregelatinized wheat flour used | — | Comp. Ex. 1 | Ex. 4 | Ex. 8 | Comp. Ex. 2 |
| as ingredient | Pregelatinized wheat flour | — | 5 | 5 | 5 | 5 |
| | (parts by mass) | | | | | |
| | Wheat flour (parts by mass) | 100 | 95 | 95 | 95 | 95 |

| | | | | | |
|---|---|---|---|---|---|
| Texture of refrigerated pan-fried gyoza dumplings | 2.3 | 3.3 | 4.1 | 4.5 | 3.1 |
| (Perfect score: 5 points) | | | | | |

### Production Examples F1 to F5: Production of Prawn Tempura

Prawn tempura, which is a kind of deep fried food, was produced by using a tempura batter mix according to a composition shown in Table 7 given below. In the tempura batter mix, soft wheat flour (“Flower” available from Nisshin Seifun Co., Ltd.) was used as wheat flour, and wheat starch (“Ginrin, modified starch for food” available from Glico Nutrition Co., Ltd.) was used as starch. The specific production method was as follows. First, a coating batter was prepared by adding an appropriate amount of water to 100 parts by mass of the tempura batter mix. Next, raw peeled prawns with tails (20 g each) were dipped in the coating batter until fully coated, and the prawns coated with the coating batter were deep fried in salad oil at 170° C. in a fryer for 2 minutes and 30 seconds, to thereby obtain pieces of prawn tempura.

After the pieces of prawn tempura produced in the above-described manner were removed from the fryer, excess oil was dripped off, and thereafter they were left at room temperature (about 25° C.) for 60 minutes. After that, the pieces of prawn tempura were eaten by 10 expert panelists to evaluate the texture of the prawn tempura on the following evaluation criteria (perfect score: 5 points). The results (the average of evaluation scores from the 10 panelists) are shown in Table 8 given below.

### Evaluation Criteria for Texture of Prawn Tempura

5 points: The texture was very good with crispy and brittle coating.

4 points: The texture was good with crispy coating.

3 points: The texture was somewhat good but the coating was less crispy.

2 points: The coating was somewhat hard or soggy with less crispiness.

1 point: The texture was poor with too hard or soggy coating having no crispiness.

TABLE 8

| | | Production Example F | | | | |
|---|---|---|---|---|---|---|
| | | 1 | 2 | 3 | 4 | 5 |
| Composition of mix | Pregelatinized wheat flour used | — | Comp. Ex. 1 | Ex. 4 | Ex. 8 | Comp. Ex. 2 |
| | Pregelatinized wheat flour | — | 2 | 2 | 2 | 2 |
| | (parts by mass) | | | | | |
| | Wheat flour (parts by mass) | 95 | 93 | 93 | 93 | 93 |
| | Starch (parts by mass) | 5 | 5 | 5 | 5 | 5 |

| | | | | | |
|---|---|---|---|---|---|
| Texture of prawn tempura after storage at room temperature | 2.8 | 3.1 | 3.4 | 4.0 | 3.0 |
| (Perfect score: 5 points) | | | | | |

### INDUSTRIAL APPLICABILITY

According to the present invention, there is provided pregelatinized starch that can improve the taste and texture of food and impart aging resistance to the food.

In the case where whole grain cereal flour is used as cereal flour, there is provided pregelatinized starch (pregelatinized whole grain cereal flour) that has a reduced distinctive odor and astringent taste characteristic of whole grain cereal flour, and the pregelatinized whole grain cereal flour can improve the taste and texture of food, and impart aging resistance to the food.

In the case where the pregelatinized starch produced according to the present invention is incorporated in bakery food, a fluffy and soft texture, a moist texture, and pleasant stickiness are imparted to the bakery food, and aging resistance is also imparted, which can prevent degradation in taste and texture over time. The same advantageous effects can also be obtained in the case where the pregelatinized starch produced according to the present invention is incorporated in noodles or deep fried food. In the case where the pregelatinized starch is incorporated in instant noodles, reconstruction of the instant noodles with hot water can be improved.

1. A method for producing pregelatinized cereal flour, comprising:
a pregelatinization step of heating a slurry containing 100 parts by mass of cereal flour and 500 parts by mass or more of water under a condition that the temperature of the slurry is 90° C. or more, to pregelatinize starch contained in the cereal flour; and
a drying step of drying the slurry from the gelatinization step to obtain a solid;
wherein, in the pregelatinization step, the slurry is stirred while heating the slurry.

2. The method for producing pregelatinized cereal flour according to claim 1,
wherein, in the pregelatinization step, the slurry is heated under a condition that the temperature of the slurry is 100° C. or more.

3. The method for producing pregelatinized cereal flour according to claim 1,
wherein, in the pregelatinization step, the slurry is heated under a condition that the temperature of the slurry is 110 to 140° C.

4. The method for producing pregelatinized cereal flour according to claim 1,
wherein wheat flour is used as the cereal flour.

5. The method for producing pregelatinized cereal flour according to claim 1,
wherein whole grain cereal flour is used as the cereal flour.

6. The method for producing pregelatinized cereal flour according to claim 1,
wherein, in the pregelatinization step, the amount of solvent contained in the slurry is not varied while heating the slurry.

7. The method for producing pregelatinized cereal flour according to claim 6,
wherein, in the pregelatinization step, the slurry is heated in a pressurized atmosphere.

8. The method for producing pregelatinized cereal flour according to claim 1,
wherein the pregelatinized cereal flour has a pregelatinization degree of 90% or more.

9. A method for producing processed food,
wherein pregelatinized cereal flour produced using the method for producing pregelatinized cereal flour according to claim 1 is used.

10. The method for producing processed food according to claim 9,
wherein the processed food is bakery food, noodles, or deep fried food.
